(19) United States
(12) Patent Application Publication
(10) Pub. No.: US 2020/0272414 A1
(43) Pub. Date: Aug. 27, 2020

(54) CHOOSE YOUR READER

(71) Applicant: Michael Coles, Dallas, TX (US)

(72) Inventor: Michael Coles, Dallas, TX (US)

(21) Appl. No.: 16/798,308

(22) Filed: Feb. 22, 2020

Related U.S. Application Data
(60) Provisional application No. 62/809,166, filed on Feb. 22, 2019.

(51) Int. Cl. G06F 3/16; H04M 1/725; H04M 11/10; G06F 3/0481

(52) U.S. Cl. CPC G06F 3/167; H04M 1/7255; G06F 3/165; G06F 3/04817; H04M 11/10

(57) ABSTRACT

A storybook application to provide an audio recording of a story recorded by Reader and delivered to Recipient via a link, eliminating the need for paper books and recording devices. A Reader, guided by highlighted story text, records their voice reading a story into the application. Upon completion of the recording, Reader saves or deletes the recorded story. A link to the recorded story is delivered to the chosen Recipient via email or text message with an optional note. The Recipient receives a link and clicks the link to access the recorded story within the application via Recipient's personal device. The words of the story are also highlighted to guide the reading pace of the Recipient, which may be altered to suit the Reader. The application also presents the stories in other languages to facilitate the acclimation and learning of foreign language for Recipients.

### FIELD OF THE INVENTION

The present disclosure relates generally to books, specifically digital books with personalized audio recorded readings of the text.

### BACKGROUND

Story time is an important part of childhood for many families, parents and children. Reading to children develops and increases literacy and language skills for young children. Unfortunately, parents are not always available for daily or nightly story time with their children. For instance, parents may not live with their child due to divorce or separation. Some parents may have to work past bedtime or may be working out of town. Additionally, some parents or family members may not be alive throughout the entire childhood of their loved ones. Currently adults have the option of recording their voices for playback while a child flips through a story book. However, recorded books lack convenience, portability, and may be prohibitively expensive.

With a typical recorded book, the child will be burdened with operating the recording device and simultaneously turning the pages of the book. If the recording device loses power, the audio reading of the story becomes unavailable. If the adult does not live with the child, the adult will need to make arrangements to deliver the book and the recordings to the child. Transport and delivery become more burdensome as the number of books increases. Adults also have the options of purchasing a book with an integrated recorder, such as through a greeting card store, bookstore or other retailer. However, the child will not be able to enjoy the book with prerecorded audio until the adult either makes a hand-delivery or ships the book to the child. Depending on the distance, this could take hours or days. Both of these options require planning and postage in addition to the recording time involved. In addition, the child will not have guidance on the pace of the reading and which written words correspond to the sound. If a child decides to move back to previous pages, the child will need to locate the exact point in the recording which corresponds with the desired page. If a parent or child wishes to share the recording with another person, that person will need to take physical possession of the book, either by postal service or personal delivery of the device. In this way, traditional physical books recorded by a family member are limited to the person who has possession of the physical book. Each new copy shared with a family member requires a new book be purchased and the same story recorded, plus the attendant costs and delays related to delivery or shipment and recording time.

### OBJECTIVES

An object of one embodiment of the present disclosure is to provide personalized voice recordings that correspond to the highlighted text of an electronic personal device.

Another object of the present disclosure is to provide personalized voice recordings in multiple languages that correspond to the highlighted text of an electronic personal device.

Another object of the present disclosure is to provide access to multiple recorded stories in a compact, mobile platform.

Another object of the present disclosure is to provide access to multiple recorded stories with limited environmental impact due to paper and printing materials.

Another object of the present disclosure is to provide a reading device that shows the pace of the recording along with corresponding visual guides for the written text.

Another object of the invention is to provide audio recordings of stories that can be stored indefinitely and shared both immediately and over time through generations of a family.

### SUMMARY

Embodiments of the present disclosure, the Choose Your Reader (“CYR”) personalized audiobook system, generally provides personalized voice recordings that correspond to the highlighted text of an electronic book viewed on a personal device, such as a cellular phone, tablet, or computer. CYR users may access the application through a subscription service with monthly fees, however, other payment methods would be available in other embodiments. A typical user experience as a story reader (“Reader”) is as follows: login/signup, select a story, press the “record” button to record the first page, read aloud into microphone by following highlighted words, press next page, press “record” button to record second page, read aloud following highlighted words, press next page, continue the same process for each page until the story is finished, save the story, share the story via email, text, or other messaging platform select a contact to receive story, and then send the link with a message to the recipient. A typical user experience as a story recipient (“Recipient”) is as follows: receive the story link via email, text, or other message platform, press the link, CYR app automatically opens within personal electronic device, the new story appears in My Stories page of CYR, select the new story, press “play” button to play first page, press next page, press “play” button to play second page, continue same process until story is finished. After the story. Recipient may replay the same story, choose another prerecorded story sent to the story Recipient via CYR, or a story recorded and saved on the to the Recipient's personal device.

While this embodiment discusses content from a specific reader user, other embodiments may incorporate generic content preloaded in CYR before a user generates content. When a Reader opens the CYR app, the Reader will see a home page. The reader has the option to sign-up for a new account or login into an existing account. Readers may use email addresses as user names and create a personalized password to access the CYR account. The reader may also reset the password if the password is forgotten. The reader may create or update a reader profile by clicking “My Profile.” Under “Settings” the reader may change their password, review Terms and Conditions of CYR, or send an email to the CYR administrator. The cover page informs the user of the story title and story author. At any time, the user may return to the My Stories screen by clicking “Play” to return to saved stories in CYR. The reader may also return to the main menu by clicking “Home”.

Upon clicking “Home”, CYR provides the options available to the Reader after logging in the CYR app. After choosing Record, the Reader may choose a category of story to record, for example, adventure, nonfiction, science fiction, history, or another type of story. After choosing a category, Reader will see various icons for the stories that are available for reading and recording in “Choose a Story”. The reader may record a new story by clicking “Record a Story.” “Record” and “Play” icons are available within CYR. Selecting “Record” leads the Reader to select a category and then to Choose a Story. Selecting “Play” leads the Reader or the Recipient to the saved stories in My Stories.

Reader may access stories that have been previously stored in “My Stories.” A Reader may then “Share the Story” with a selected recipient or “Delete the Story” if the recording is not satisfactory or if the reader wants to rerecord the story inside the CYR app. Once the Reader decides to “Share the Story”, the Reader may select a Recipient from their phone or email contact list. The reader also has the option to send a generic note or a personalized note to the Recipient. The Recipient will receive either a text message or email with a link for the recorded story saved within CYR. Once the Recipient clicks on the link in the text message or email, the Recipient will be redirected to either the CYR app or website to access the pre-recorded story. Once the story is received, the Recipient will download the prerecorded story and view the Reader's message, if there was a message sent along with the story. The stories received and downloaded by Recipient will be shown on the My Stories page of Recipient. The Recipient is now free to listen to the story, go back to a previous page or fast forward to later pages in the story. The Recipient may listen to the story as many times as the Recipient desires and from a variety of electronic devices such as phones, tablets, computers, as long as the CYR app or website is accessible. Once the story ends, the Recipient may listen again or select another story for their listening pleasure if Recipient has additional stories downloaded to “My Stories”.

In use, a Reader will select a story from the CYR platform or application. The CYR app may include original content from CYR creators, licensed content from authors, bookstores, libraries, or original content by Reader or Recipient. In order to select a story, a Reader will touch the icon of the desired story. CYR will display the words of the story, with individual words of text highlighted to guide the Reader of select words highlighted, to guide the pace of the reader so that the reader may be on pace with the recordings of the text, similar to the guides provided by karaoke disks (words highlighted to help the singer follow the pace of the song). The Reader may increase, decrease, or maintain the pace of the read content in CYR to their individual preferences. The Reader will read each page of the story and record the audio into CYR page by page to create the audio story file. Once the Reader finishes the story, the Reader will have the option of saving or deleting the audio story file. Once the audio story file is saved, the Reader may send the audio story file to the Recipient, who may or may not be a child, via a communication method such as electronic mail or cellular phone text message. The link to the audio story file from Reader will direct Recipient to the story previously recorded by Reader and subsequently stored within the CYR app. The Reader may choose to include a personalized note to Recipient (for example, Enjoy this story. I will definitely be at your birthday party next week!”) or generic note (for example, “I made this story for you. Hope you like it.”) The Reader may also send the file to multiple recipients. In addition. Recipient may communicate with Reader through CYR app via electronic mail or text messages (for example, “Thanks for the story Dad. That was awesome. See you next weekend!”). CYR may also coordinate with other apps, such as SMS (short message service), social media messaging platforms, WhatsApp, or GroupMe, to facilitate communication between Readers and Recipients.

After the story is recorded by Reader, the story is stored in the Reader's CYR app for future sharing with the original Recipients or new Recipients. Further, the recorded story may be stored indefinitely in cloud or other storage methods for later access by both the Reader or the Recipient. Any person who has the story link and the CYR app may access and enjoy the story on any personal device. Upon receipt, the Recipient may open the message, access the link and play the recorded story. As the recorded content plays, the content previously recorded by Reader is displayed in coordination with the highlighted words of the story from the CYR app.

Access to CYR, content is not limited by access to paper books, battery life of audiobook device or battery life of a recording device used in concert with a paper book. The recipient may access recorded audio story files via multiple methods such as a phone, tablet or computer, as long as the link sent from Reader to Recipient is accessible and Recipient has access to a working personal device with internet capabilities. The Recipient also has the ability to transport and store multiple stories without the bulkiness of paper books. The number of stories on a personal device is not limited even by storage capacity since the content does not have to be stored on the personal device. Downloading of content to a personal device is optional. A child could easily have a number of stories stored on their personal device for their listening pleasure during a family road trip, a night with the babysitter, or a summer with the grandparents. CYR is not susceptible to loss, damage or destruction as is the case for paper books or electronic reader devices, which may be handled roughly or misplaced or damaged by natural or unnatural elements. The recorded audio story file secured in CYR is always available via multiple platforms as long as the CYR app has been downloaded. CYR users are also able to quickly coordinate the sound of the reader's voice with the corresponding highlighted words without the guidance of the person reading the text (i.e. using reader's finger to point to words as they are read aloud). Additionally, Readers may increase or decrease the speed of the recordings to accommodate their personal preference. The text displayed on CYR will coordinate with the audio as selected by the Reader.

Once the recording is saved by the Reader, the CYR app uploads the file in proprietary file format as a story audio file, which is stored on the CYR server. Any recipient who has the link to the specific recorded CYR story may access the recording by simply clicking on the link. Once the link is clicked, the proprietary story audio file is instantly downloaded to the CYR app inside the user's personal device. Once the story audio file is downloaded to a personal device, the CYR story may be accessed even if there is no internet or Wi-Fi available.

An alternative embodiment of CYR uses pre-recorded voices in multiple languages, including English. Once the user has become familiar with the story in the Recipient's native language, the user has the option of changing the audio to Spanish, Chinese, Russian, Swahili, or any other language in which the story has been pre-recorded. The user's familiarity with the story may aid the user in gaining comfort and familiarity with another language. For example, the user may have a friend or relative who speaks an unfamiliar language. In addition, parents or children may have never been to their family's home country and be unfamiliar with that language. Other technical features may be readily apparent to those skilled in the art from the following figures and descriptions.

### BRIEF DESCRIPTION OF THE DRAWINGS

For a more complete understanding of this disclosure and its features, reference is now made to the following description, taken in conjunction with the accompanying drawings, in which:

FIG. 1 shows the My Stories screen for CYR.

FIG. 2 shows the text of a story during use of Record a Story feature of CYR.

FIG. 3 shows the Share Story feature of CYR.

FIG. 4 shows the Send a Note feature of CYR.

FIG. 5 shows the text of the note sent in CYR.

FIG. 6 shows the Play a Story feature of CYR.

FIG. 7 shows an overview of the CYR system for a Reader and Recipient.

### DETAILED DESCRIPTION

The present disclosure generally provides an application for personalized electronic books, specifically stories with personalized audio recorded readings of the text.

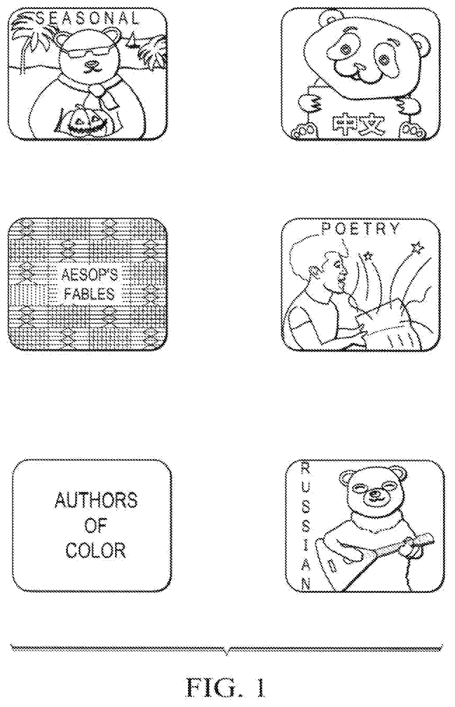

FIG. 1 shows the My Stories screen for CYR. After logging into the CYR app, the CYR menu screen provides the options available to the reader. One of those options is saved stories in “My Stories”, where the Reader may access stories that have been previously recorded and stored in “My Stories.” The Reader may also record a new story by clicking “Record a Story.” If no stories have been recorded, the reader may see either no story icons or icons for generic sample story content, that may be deleted upon the recording of personalized stories by Reader. Once a particular story is selected from the My Stories screen, the cover page of the selected story is displayed within CYR.

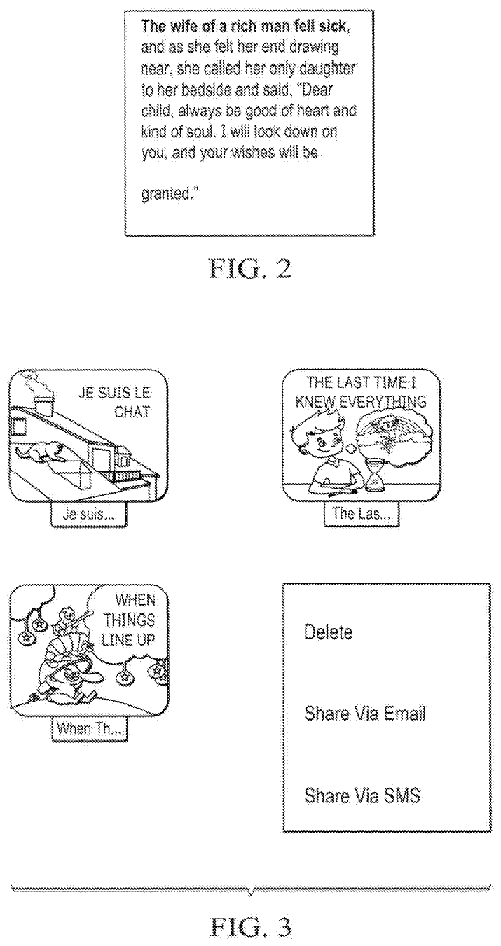

FIG. 2 shows the text of a story during use of Record a Story feature of CYR, which is displayed after the cover page of the selected story in CYR. The next screen is the text of the story, shown in FIG. 2. The text of the story will be highlighted or otherwise marked (ex: via contrasting color, font, boldness, etc.) to indicate which words of text a Reader is to read aloud during recording. After a word of text is recorded by Reader, the highlighting moves along to the next word which continues until the full page of text has been read and recorded by Reader. The same process occurs for each page of the story. In this particular example, the highlighting is hold, whereby the bold text indicates which word the Reader should read aloud and record into CYR. However, the text which has not yet been read aloud by Reader remains unchanged (not bold in this example). As the reading progresses, the boldness of words in the CYR story continues to change to indicate the next word to be read by Reader. In addition, the page counter at the bottom of the CYR screen displays the page number of the story being read. If the Reader is recording the story, the Reader will speak into the mobile phone or tablet microphone as the story is read and recorded. Upon completion of the reading of the story, the Reader may choose whether to cancel or save the story audio file.

FIG. 3 shows the Share Story feature of CYR. After the story has been read, recorded, and saved, the icon for the recorded story audio file will appear on the My Stories page, where the Reader may choose to delete or share the story audio file, via email, SMS, or other similar electronic communication method. The selection of Delete will remove the story audio file from CYR. The selection of Share via email will send the story audio file link to the email address of the selected Recipient. Share via SMS will text the story audio file link to the cell phone of the Recipient. Once the user or contact receives the link to the story audio file, the Recipient may access the recorded story audio file by clicking on the story link, which will access the story audio file within the CYR app, provided the Recipient has previously downloaded the CYR app to his or her personal electronic device.

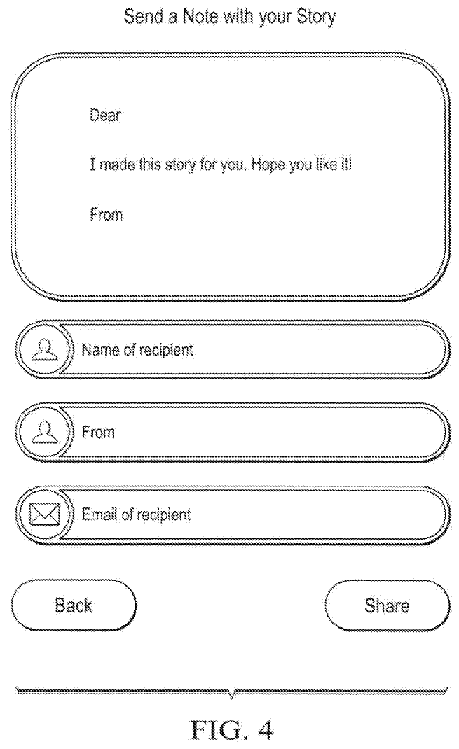

FIG. 4 shows the Send a Note feature of CYR. In addition to sending a story audio file link to the recorded story to the Recipient, a Note is sent along with the audio file. Reader may choose to send either a personalized note to the Recipient or to send a generic, prewritten note to the Recipient. After the story has been recorded and saved to CYR, Reader may select any of the contacts from his or her stored contacts, with whom to share the story audio file link. Once a contact is selected, the Reader's name is populated in the “From” field. The Reader may also enter the email address for the Recipient or select the email address from the Reader's contacts, in this embodiment, but a similar process would occur for story links sent via text message or other communication methods. If a Reader wants to return to a prior screen within CYR. Reader may select the “Back” icon. If the Reader wants to share the story with the Recipient whose details have just been entered in this Send a Note feature, Reader may click the “Share” icon.

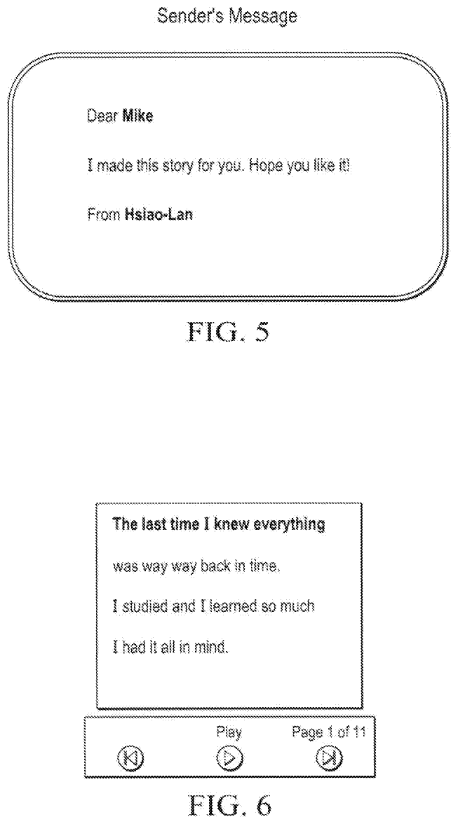

FIG. 5 shows the text of the note sent in CYR. Once the Reader identifies a Recipient and enters the contact information for said Recipient, a message is generated in CYR to that Recipient. At this stage, the names of the Reader and Recipient have been added to the note. The message shown in this figure is generic but the message may be personalized by Reader. This message may be shared with the Recipient by selecting “Share” or modified by selecting “Back” to return to the prior screen for modifications of Recipient or the text of the message.

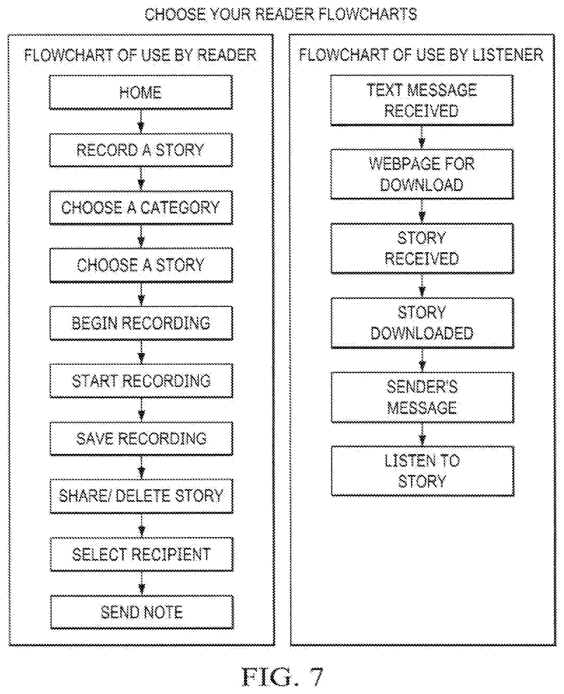

FIG. 6 shows the Play a Story feature of CYR. Once the Recipient receives either a text or email with a link to the personalized story audio file, the recipient may access the link by clicking or touching the link. The Recipient may listen to the story audio file immediately from the CYR app or download the story audio file to the Recipient's personal device for listening now or later. Once the story audio file has been downloaded to the Recipient's device, the recipient will press the “Play” icon to start the pre-recorded reading the story. The recipient will hear Reader's voice synchronized with the selected or highlighted text displayed on the screen. In this embodiment, the words previously recorded by Reader and simultaneously heard by Recipient are highlighted in bold lettering (however, in alternative embodiments the read text may be distinguished by contrasting colors or fonts). If Recipient wants to return to a previous page, the recipient will touch the back-arrow icon at the bottom left of the display screen. If the Recipient wants to move ahead to a later page, the Recipient would touch the forward-arrow icon at the bottom right of the display screen. This display also includes a page counter so the recipient knows how many pages of the story are remaining and to guide backward and forward movement through the pages of the story audio file in CYR.

FIG. 7 shows an overview of the CYR system for a Reader and Recipient. When a Reader opens the CYR app, the Reader will see a home page. The reader has the option to sign-up for a new account or login into an existing account, create or update a Reader profile, change their password, review Terms and Conditions of CYR, or send an email to the CYR administrator. If the user is a Reader, that user may select Record a Story to enter the Reader track of CYR and Choose a Category of Story to read. Readers will have the option to choose from a variety of genres of stories. Once Reader selects a genre, the reader may Choose a Story, where all content available to be recorded is stored in the CYR. Once a story is chosen, Reader may Begin Recording, wherein the reader will see a page of the story text with select words highlighted or bolded. During Start Recording, Reader will read the highlighted text aloud as the story progresses and until each page is read aloud and the audio of Reader recorded into CYR. Upon completion of the reading of each page of the story by Reader, the Reader may choose to Save Recording, in order to save the story audio file to CYR. Reader may decide to Share or Delete Story. If Reader decides to Share Story, then Reader must select a Recipient for the story audio file. Reader may then send the story audio file with an optional note, which may be generic or personalized to Recipient. When a Listener/Recipient opens the CYR app, the Recipient will see a notice that Text Message Received (or an email or other communications means in alternative embodiments). The message from Reader will include a link to the recorded story audio file from Reader. Once Recipient clicks the link in the message from Reader, the story audio file is received and accessible to Recipient, via download to the Recipient's personal device for viewing/listening pleasure now or later. The Recipient is also now able to view the message from Sender/Reader. The Recipient may now proceed to Listen to Story. Recipient may listen to the story audio file as few or as many times as desired. If the story audio file has been downloaded. Recipient may continue to enjoy the story audio file without Wi-Fi or internet access.

What is claimed is:

1) A system for generating personalized audio content accessible via cloud storage, wherein a first user creates an audio recording of story text synchronized to corresponding written story text displayed within an application, wherein a second user receives said audio recording of story text via said application.

2) The system of claim 1, wherein said audio recording is comprised by said first user reading said written story text aloud, said first user recording said reading of said written story text, said first user saving said recorded reading of said written story text in an audio file, wherein each page of said written story text is paired with the corresponding portion of said audio file.

3) The system of claim 2, wherein said recorded reading of said written story text is stored within said application, wherein said recorded reading of said written story may be accessed by selecting said written story from said application.

4) The system of claim 3, wherein said first user accesses said recorded reading of said written story within said application.

5) The system of claim 3, wherein said first user shares said audio file of said recorded reading of said written story by sending said link to said second user, wherein said first user generates a note to said second user, wherein said first user selects contact information for said second user, wherein said second user receives said recorded reading of said story, wherein said second user receives said note from said first user.

6) The system of claim 4, wherein said first user deletes said recorded reading of said written story to remove said recorded reading of said written story from said application.

7) The system of claim 5, wherein said second user receives said note composed by said first user, wherein said second user selects said link to access said audio file of said recorded reading of said written story text.

8) The system of claim 7, wherein said second user views said note within said application.

9) The system of claim 8, wherein said second user downloads said audio file from said link in said note, wherein said second user saves said audio file to said application on the personal device of said second user, wherein said second user listens to said audio file from said personal device of said second user.

10) The system of claim 9, wherein said second user chooses an icon selected from the group consisting of: play to listen to the selected page of said story, back to listen to the previous page of said story, and forward to listen to the next page of said story, wherein said corresponding portion of said audio file automatically plays based on the page chosen by said second user.

11) The system of claim 9, wherein said second user sends a return note to said first user within said application.

12) The system of claim 1, wherein said synchronized story text is comprised of highlighted text and nonhighlighted text, wherein said highlighted text of said story text indicates which section of said story said first user is recording into said audio file, wherein said highlighted text of said story text progresses along said story text until the highlighted text is the last word of said story text.

13) The system of claim 12, wherein said first user saves said recorded story text into said audio file upon completion of said first user's reading of said story text, wherein said first user shares said audio file with said second user, wherein said second user listens to said audio file.

14) The system of claim 12, wherein said first user saves said recorded story text into said audio file upon completion of said first user's reading of said story text, wherein said first user listens to said audio file within said application on said personal device.

15) The system of claim 12, wherein said second user chooses an icon selected from the group consisting of: play to listen to the selected page of said story, back to listen to the previous page of said story, and forward to listen to the next page of said story, wherein said corresponding portion of said audio file automatically plays based on the page chosen by said second user.

16) The system of claim 5, wherein said note may be delivered by a communication system selected from the group consisting of: electronic mail, short message service (SMS), social media messaging platforms, cellular phone text message, and instant messaging applications.

17) The system of claim 11, wherein said return note may be delivered by a communication system selected from the group consisting of: electronic mail, short message service (SMS), social media messaging platforms, cellular phone text message, and instant messaging applications.
